(19) United States
(12) Patent Application Publication
(10) Pub. No.: US 2015/0286544 A1
(43) Pub. Date: Oct. 8, 2015

(54) FAULT TOLERANCE IN A MULTI-CORE CIRCUIT

(71) Applicant: HEWLETT-PACKARD DEVELOPMENT COMPANY, L.P., Houston, TX (US)

(72) Inventor: Rachid M. Kadri, Houston, TX (US)

(21) Appl. No.: 14/435,786

(22) PCT Filed: Nov. 29, 2012
(86) PCT No.: PCT/US2012/067085

§ 371 Date: Apr. 15, 2015

(51) Int. Cl. G06F 11/20

(52) U.S. Cl. CPC G06F 11/2033; G06F 11/2043

(57) ABSTRACT

Examples disclose a multi-core circuit with a primary core associated with a primary portion of cache and a secondary core associated with a secondary portion of the cache. The secondary portion of the cache is redundant to the primary portion of the cache. Further, the examples of the multi-core circuit provide a control circuit to enable the secondary core for operation in response to a fault condition detected at the primary core, wherein the secondary portion of cache is enabled with the secondary core to resume an operation of the primary core.

### BACKGROUND

A multi-core processor integrates multiple cores for processing program instructions to perform various tasks within a computing device. Utilizing the integration of multiple cores into a single processing component may increase the efficiency for performing the various tasks; however, the multi-core processor may be limited in providing fault protection.

### BRIEF DESCRIPTION OF THE DRAWINGS

In the accompanying drawings, like numerals refer to like components or blocks. The following detailed description references the drawings, wherein:

FIG. 1 is a block diagram of an example multi-core circuit with a primary core and a secondary core, each core associated with a portion of cache and a control circuit to enable the secondary core for operation in response to a fault detected at the primary core;

FIG. 2 is a block diagram of an example multi-core circuit with a primary core and secondary core associated with a primary portion and a secondary portion of cache, the example multi-core circuit also includes a control circuit to detect a fault condition at the primary core, register tiles for updates from the primary core, and multiple levels of cache;

FIG. 3 is a flow chart of an example method to provide fault tolerant protection within a multi-core circuit by partitioning cache into primary and secondary portions, detect a fault condition associated with a primary core, and operate the secondary core in response to the detected fault condition;

FIG. 4 is a flowchart of an example method to provide fault tolerant protection within a multi-core circuit by detecting a fault condition associated with a primary core through an error correcting code, operating the secondary core in response to the detected fault condition associated with the primary core for re-execution of data; and

FIG. 5 is a block diagram of an example computing device with a processor to obtain data from a primary portion of cache for execution associated with a primary core and operate a secondary core in response to a detected fault condition associated with the primary core.

### DETAILED DESCRIPTION

A multi-core processor may be limited in providing fault protection as fault tolerant systems may be reserved for larger and/or more expensive systems. For example, fault protection may be provided through external redundant components which increase the cost, real estate, and complexity of the system architecture. In another example, fault protection may be provided through components that may take over data processing when other components suffer a fault. This causes the components and/or resources in the system to drag and/or become inoperable.

To address these issues, example embodiments disclosed herein provide a multi-core circuit with primary and secondary cores, each associated with primary and secondary portions of cache. The secondary portion of the cache is redundant to the primary portion of the cache enabling a partitioning of the cache to provide the redundant memory without the external component. Partitioning the cache into primary and secondary portions enables the secondary core to resume an operation that may not have been fully executed by the primary core due to a fault condition. Additionally, this creates a redundant data set in the secondary portion of the cache, providing another level of fault protection as the multi-core circuit may resume operations if a fault exists in the primary portion of cache.

Additionally, the multi-core circuit includes a control circuit to enable the secondary core for operation in response to a fault condition detected at the primary core. The secondary portion of the cache is enabled with the secondary core to resume an operation of the primary core. Enabling the secondary core for operation in response to a fault within the primary core, provides fault protection at the multi-circuit level without the addition of an external component. Further, this adds fault tolerant functions within the system without increasing the resources, such as cost, design, and space. Furthermore, this enables the multi-core circuit to operate in a dual mode in which the secondary core is a back-up to the primary core within the existing structure without adding additional resources as the cores are integrated as part of the multi-core circuit. For example, the multi-core circuit may operate in normal mode with the primary core processing the data while the secondary remains idle. In another example, the multi-circuit may operate in fault tolerant mode when enabling the secondary core to take over for the primary core. Yet, further still, enabling the secondary portion of the cache with the secondary core enables the multi-core circuit to resume the operation of the first core by utilizing the redundant cache.

In another embodiment, the multi-core circuit includes a dual port register file between the primary and the secondary cores. Utilizing the dual port register file, communications may be used for reading and writing between the primary and the secondary cores. This enables the dual port register file to receive in real time an update or change of control and status data from the primary core. The dual register file may provide this updated data to the secondary core, thus ensuring the secondary core resume and/or re-execute an operation of the primary core.

In summary, example embodiments disclosed herein provide fault protection to a multi-core circuit while avoiding component redundancy and without increasing resources. Further, example embodiments provide effective utilization of multiple cores by providing a seamless operation for the multi-core circuit to switch from the primary core to the secondary core upon the fault detection.

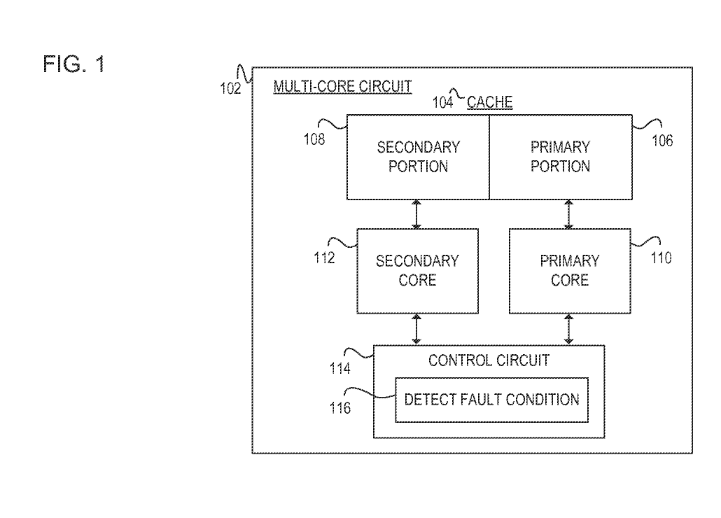

Referring now to the figures, FIG. 1 is a block diagram of an example multi-core circuit 102 including a primary core 110 associated with a primary portion 106 of a cache 104 and a secondary core 112 associated with a secondary portion 108 of the cache 104. Additionally, the multi-core circuit 102 includes a control circuit 114 to detect a fault condition at module 116 associated with the primary core 110. The control circuit 114 enables the operation of the secondary core 112 in response to the fault detected of the primary core 110 at module 116. Further, the dual arrow between each of the components 106, 108, 110, 112, and 114 represents the duality of the communications between the various components 106, 108, 110, 112, and 114. For example, the primary core 110 may obtain data from the primary portion 106 of the cache 104 for execution and then write data back into the primary portion 106 of the cache 104.

The multi-core circuit 102 is an electrical circuit with multiple cores 110 and 112 that read , write, and execute data obtained from the portions of the cache 106 and 108, Specifically, the data includes instructions and/or commands for the cores 110 and 112 to perform an operation(s) to complete a task. The multi-core circuit 102 includes multiple cores 110 and 112 on a motherboard to improve processing time as it allows a computing device in which the circuit 102, is implemented to handle more complex tasks. The cores 110 and 112 are considered the brains of the computing device, as instructions and/or commands may be executed by either core 110 or 112 to complete the tasks. As such, embodiments of the multi-core circuit 102 include a multi-core processor, multi-core socket, integrated circuit, printed circuit board, multi-core controller, multiprocessor, central processing unit, graphics processing unit, or other type of multi-core circuit 102 which includes multiple cores 110 and 112 for reading and executing data from cache 104. Additionally, although FIG. 1 illustrates the multi-core circuit 102 as including two cores 110 and 112, embodiments should not be limited as this was done for illustration purposes. For example, the multi-core circuit 102 may include four cores and may be referred to as a quad-core circuit, six cores and may be referred to as a hexa-core circuit, etc.

The primary core 110 is a processing unit as part of the multi-core circuit 102 that may read, write, and or execute data obtained from the primary portion 106 of the cache 104 to perform an operation. The data obtained from the primary portion 106 of the cache 104 may include an instruction and/or command for the primary core 110 to perform. the operation. For example, the data may include a series of bits of information entailing an instruction for execution, so once executed the primary core 110 may write the results of this data back into the primary portion 106 of the cache 104. The primary core 110 continues executing data until the fault condition is detected at module 116, at which point the data execution switches over to the secondary core 112. Embodiments of the primary core 110 include an execution unit, processing unit, processing node, executing node, or other type of unit capable of performing an operation by reading, writing, and/or executing data.

The secondary core 112 is an additional processing unit as part of the multi-core circuit 102, which reads, writes, and executes data to perform various operations. The secondary core 112 is considered associated with the secondary portion 108 of the cache 104, as data may be obtained for execution from the secondary portion 108 of the cache 104. Additionally, the secondary core 112 is enabled to resume an operation of the primary core 110 once the fault condition is detected at module 116. in this embodiment, the secondary portion 108 of the cache 104 contains a redundant set of data of the primary portion 106. Address pointers may each be associated with the primary portion 106 and the secondary portion 108 of the cache 104. The address pointer associated with the primary portion 106 which is one data instruction ahead of the address pointer associated with the secondary portion 108 of the cache 104. The control unit 114 enables the address pointer of each portion 106 and 108 of the cache 104 to increment until the fault condition is detected with the primary core 110, thus enabling the secondary core 112 to resume an operation of the primary core 110. In one embodiment, the secondary core 112 remains idle (i.e. not executing data) until the fault condition is detected within the primary core 110 and/or the primary portion 106 of the cache. In another embodiment, the secondary core 112 may execute lower priority data until the fault condition is detected within the primary core 110. The secondary core 112 may be similar in structure and functionality to the primary core 110 and as such, embodiments of the secondary core 112 include an execution unit, processing unit, processing node, executing node, or other type of unit capable of performing an operation by reading, writing, and/or executing data.

The cache 104 is memory used by the multi-core circuit 102 to reduce the time to access frequently used data. The cache 104 is considered a faster memory which stores copies of data most frequently accessed by the cores 110 and 112 for performing various tasks. Embodiments of the cache 104 include memory, storage, or other area of fast memory used by the cores 110 and 112 to obtain data for reading, execution, and writing.

The primary portion 106 and the secondary portion 108 of the cache 104 are each an area of the cache 104 associated their respective cores 110 and 112. Specifically, the portions 106 and 108 store data for the cores 110 and 112 to obtain for data reading and execution and also for writing the data back to the portions 106 and 108. The secondary portion of the cache 108 is the area of the cache 104 containing a redundant data set to the primary portion 106 and is associated with the secondary core 112. The redundant data set in the secondary portion 108 enables the secondary core 112 to resume the operation of the primary core 110 prior to the fault detection. In another embodiment, if data corruption is detected within the primary portion 106 of the cache 104, the primary portion 106 may be disabled from the cache 104 while the secondary portion 106 will take over as the main cache 104 for the multi-core circuit 102.

The control circuit 114 is an electrical component of various logic components on the multi-core circuit 102 capable of detecting the fault condition at module 116, the fault condition associated with the primary core 110 or primary portion 106. In one embodiment, the control circuit 114 obtains an error-correcting code (i.e., error free data) and compares the code to data written into the primary portion 106 of cache 104 from the primary core 110. In this embodiment, if the date and the code are similar, this indicates the primary core 110 is operating in a normal condition (i.e., without a fault condition). If the data and the code are mismatching, this indicates a data corruption within the primary core 110 and or the primary portion 106. The data corruption signals to the control circuit 114 the fault condition associated with the primary core 110. The control circuit 114 switches data execution from the primary core 110 to the secondary core 112 once detecting the fault condition of the primary core 110. The control circuit 114 operates as a component to the multi-core circuit 102 overseeing the data execution of the cores 110 and 112. In a fluffier embodiment, the control circuit 114 includes a synchronous digital circuit and operates to track the timer ticks for updating the secondary portion 108 of the cache 104. In this embodiment, the control circuit 114 tracks the clock cycles, which oscillate between a high and low state, so once the clock cycles reach a pre-determined number of cycles, the control circuit 114 communicates to copy the data updates from the primary portion 106 to the secondary portion 108. Embodiments of the control circuit 114 include a central processing unit, core, or other type of processing unit.

At module 116, the control circuit 114 detects the fault condition associated with the primary core 110. The fault condition is an internal data corruption that may have occurred during data execution within the primary core 110 and/or within the associated primary portion 106 of the cache 104. Embodiments of the module 116 include a set of instructions, instruction, process, operation, logic, algorithm, technique, logical function, firmware, and or software executable by the control circuit 114 to detect a fault condition associated with the primary core 110.

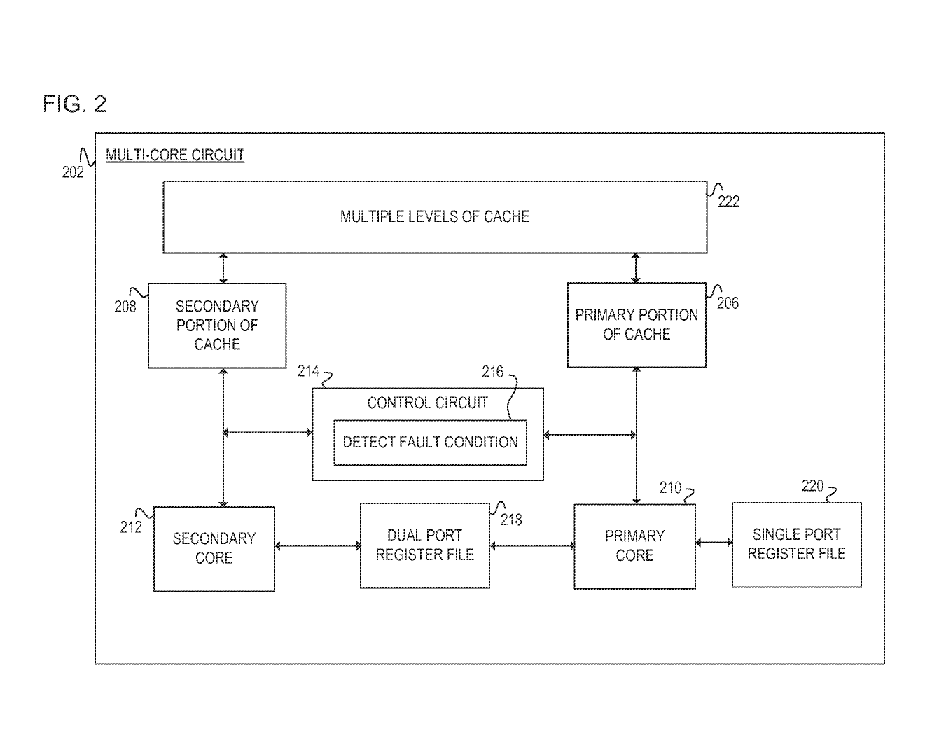

FIG. 2 is a block diagram of an example multi-core circuit 202 with a primary core 210 and secondary core 212 associated with a primary portion 206 and a secondary portion 208 of cache. The multi-core circuit 202 also includes a control circuit 214 to detect a fault condition with the primary core 210 at module 216, register files 218 and 220 for updates from the primary core 210, and multiple levels of cache 222. The register files 218 and 220 are used to communicate data between the portions of cache 206 and 208 and the cores 210 and 212 on the multi-core circuit 202. The dual arrows between the components 210, 212, 214, 218, 220, and 222 each represent the duality of the communications between these components 210, 212, 214, 218, 220, and 222. For example, the primary core 210 may obtain data from the primary portion of the cache 206 and execute this data to then write the data back to the primary portion of the cache 206. The multi-core circuit 202, primary core 210, and the secondary core 212 may be similar in structure and functionality to the multi-core circuit 102, primary core 110, and the secondary core 112 as in FIG. 1.

The primary portion of cache 206 and the secondary portion of the cache 208 are each associated with their respective cores 210 and 212 to obtain data for execution of which causes the cores 210 and 212 to perform an operation. The primary portion of cache 206 and the secondary portion of the cache 208 may be similar and structure and functionality to the primary portion 106 and the secondary portion 108 of the cache 104 as in FIG. 1.

The control circuit 214 detects a fault condition at module 216, the fault condition associated with the primary core 210. The control circuit 214 may be similar in structure and functionality to the control circuit 114 as in FIG. 1. Module 216 may be similar in functionality to the module 116 as in FIG. 1.

The single port register file 220 is an array of processor registers in the multi-core circuit 202 with a single port dedicated for communications with a single component (i.e., the primary core 210). The single port of the register file 220 is used for data reads and data writes from the primary 210. The single port register file 220 is associated with the primary core 210 to receive updates regarding the state of the core 210 and to change and/or control the behavior of the primary core 210. For example, the single port register file 220 may receive a data update of the state of the primary core 210, that the core 210 is in fault condition, thus the single port register file 220 may control the primary core 210 to halt any further data execution.

The dual port register file 218, between the primary core 210 and the secondary core 212, is an array of processor registers in the multi-core circuit 202 with at least two ports dedicated to communications between at least two components (i.e., cores 210 and 212). The two ports are used for read and write ports from the cores 210 and 212. The dual port register file 218 contains data regarding the state of the cores 210 and 212. In this embodiment, the register file 218 may change and/or control the behavior of the cores 210 and 212. For example, the dual port register file 218 may receive a data update of the state of the primary core 210 that the core is in normal operation, thus the register file 218 may control the behavior of the secondary core 212 to remain idle until the fault detection at module 216. In an embodiment, the dual port register file 218 is utilized between the cores 210 and 212 for updates from the primary core 210 regarding status and/or control data from the primary register file. In this embodiment, data is written back into the primary portion of cache 206, thus the dual port register file 218 may control writing this update to the secondary core 212, The secondary core 212 may then write this update into the secondary portion of cache 208. Further, in this embodiment the primary core 210 provides a redundant copy of data to place into the secondary portion of the cache 208.

The multiple levels of cache 222 represent the different types of cache available in the multi-core circuit 202. For example, the multiple levels of cache 222 may represent memory within the mutt core circuit 202 in which the data accessed may not be as frequently accessed as the data within the primary portion of the cache 206 and the secondary portion of the cache 208, thus having a longer latency time. In another example, the multiple levels of cache 222 may contain more data and may have a slower latency time compared to the portions of cache 206 and 208. In one embodiment, the multiple levels of cache 222. may be further partitioned to correspond to the portions 206 and 208 of cache. in another embodiment, the multiple levels of cache 22.2 may be combined with the portions of cache 206 and 208 to create a larger area of cache for the multi-core circuit 202. Embodiments of the, primary and secondary portion of the cache 206 and 208 include the smallest level of cache (L1), and embodiments of the multiple levels of cache 222 include the next larger level of cache (L2), and the largest level of cache (L3).

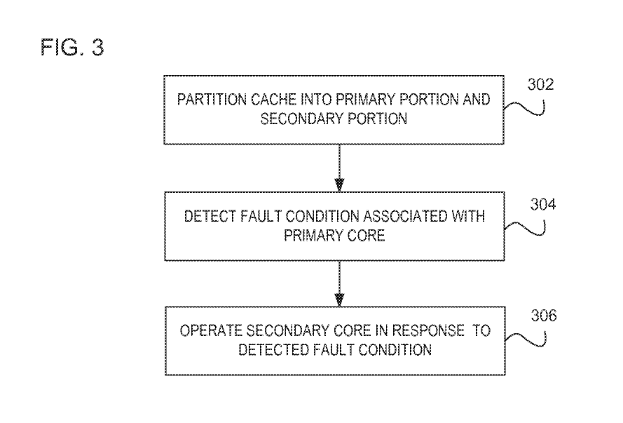

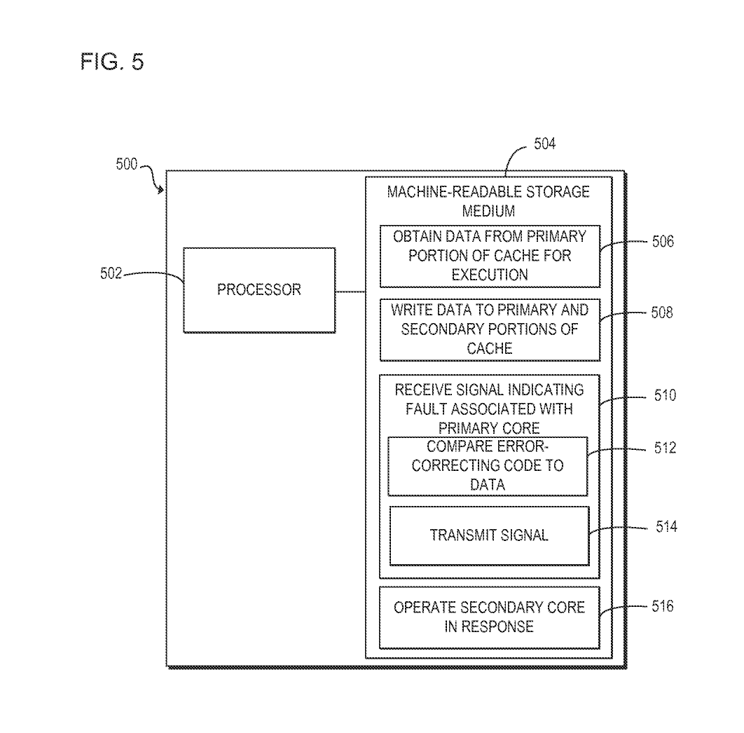

FIG. 3 is a flowchart of an example method to provide fault tolerant protection with a multi-core circuit by partitioning cache into primary and second portions, detecting a fault condition associated with a primary core, and operating a secondary core in response to the detected fault condition. In discussing FIG. 3, reference is made to FIGS. 1-2 to provide contextual examples. Further, although FIG. 3 is described as implemented on multi-core circuits 102 and 202 as in FIGS. 1-2, it may be executed on other suitable components. For example, FIG. 3 may be implemented in the form of executable instructions on a machine readable storage medium, such as machine-readable storage medium 504 as in FIG. 5.

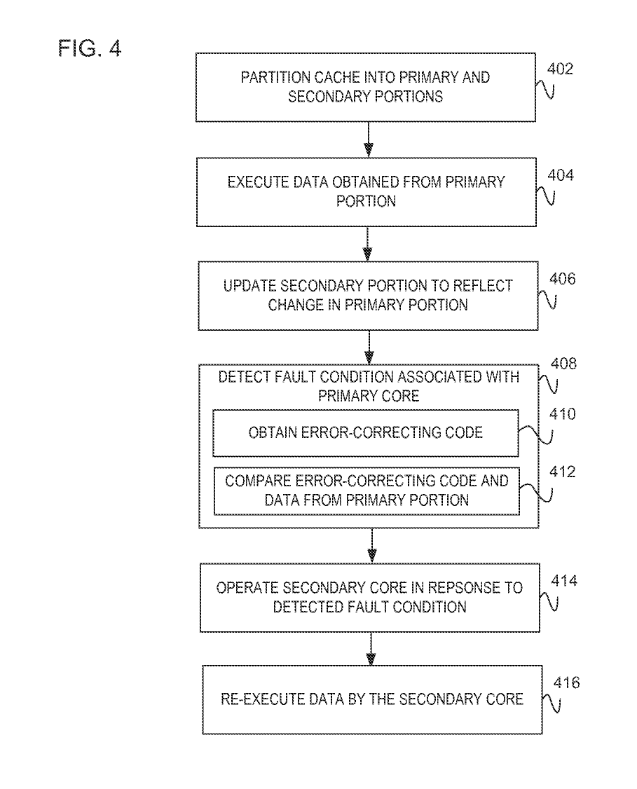

At operation 302 the cache is partitioned into a primary portion associated with a primary core and a secondary portion of cache associated with a secondary core. The secondary portion of the cache is considered redundant to the primary portion of the cache. At operation 302, the cache 104 is partitioned into the primary portion 106 and the secondary portion 108, each associated with their respective cores 110 and 112 as in FIG. 1. In one embodiment, operation 302 is implemented at the manufacturing level to divide the cache into the portions for dedication to each core. In another embodiment, the data in the primary portion of the cache is copied to the secondary portion, creating a redundant data set in the secondary portion of the cache. In this embodiment, one of the cores and/or control circuit may obtain the copy of data for storage in the secondary portion of the cache. Additionally, partitioning the cache into primary and secondary portions of the cache enables the secondary core to resume an operation that may not have been fully executed by the primary core due to a fault condition. Further, partitioning the cache into the primary and the secondary portions and creating a redundant data set in the secondary portion of the cache enables the multi-core socket to resume operations even if a fault condition exists in the primary portion of the cache. This enables the multi-circuit to provide another level of fault protection at the cache level in addition to the fault protection at the primary core. In another embodiment, operation 302, updates the secondary portion of the cache to reflect a change in the primary portion of the cache. In this embodiment, a dual port register 218 between the primary core 210 and the secondary core 212 as in FIG. 2, may update the secondary port register file and secondary portion of the cache if a status and/or other data set in the primary register file and primary portion of cache changes when the primary core is executing data or once a timer tick expires. The timer tick is tracked through the clock cycles of the multi-core circuit and thus may update the secondary cache after a number of clock cycles. These embodiments are discussed in greater detail in FIG. 4.

At operation 304, a fault condition associated with the primary core is detected by a control circuit. At operation 304, the control circuit 114 detects the fault condition associated with the primary core 110 as in FIG. 1. The primary core obtains data from the primary portion of the cache for execution, by writing the contents of the data after execution back to the primary portion of the cache, the control circuit may also obtain a copy of the written data for analysis to detect a fault condition of the primary core. In another embodiment, the control circuit uses error correcting data by comparing the data executed by the primary core to the error correcting code to detect the fault condition within the primary core. In a further embodiment, the secondary core remains idle until the fault is detected at operation 304. This enables the secondary core to remain in a stand-by mode until the fault is detected.

At operation 306, the control circuit operates the secondary core and associated secondary portion of the cache in response to the fault condition detected at operation 304. At operation 306, the control circuit 114 selects the secondary core 112 and the secondary portion 108 of cache to resume an operation of the primary core 110 in response to the detected fault condition as in FIG. 1. In another embodiment, the data obtained from the primary portion of the cache, by the primary core for execution, may be re-executed by the secondary core. This embodiment is explained in further detail in the next figure.

FIG. 4 is a flowchart of an example method to provide fault tolerant protection with a multi-core circuit by detecting a fault condition associated with a primary core through an error correction code and operating a secondary core in response to the detected fault condition associated with the primary core for re-execution of data. In discussing FIG. 4, reference is made to FIGS. 1-2 to provide contextual examples. Further, although FIG. 4 is described as implemented on multi-core circuits 102 and 202 as in FIGS. 1-2, it may be executed on other suitable components. For example, FIG. 4 may be implemented in the form of executable instructions on a machine-readable storage medium, such as machine-readable storage medium 504 as in FIG. 5.

At operation 402 a cache is partitioned into a primary portion and a secondary portion. The primary portion is associated with a primary core of a multi-core circuit and the secondary portion is associated with a secondary core. The portions of cache are considered associated with their respective core as each core obtains data from each of their associated portions of the cache. Operation 402 may be similar in functionality to operation 302 as in FIG. 3.

At operation 404 the primary core obtains data from the primary portion of the cache for execution. In this embodiment, the primary core obtains instructions to perform at least one operation to complete a task. In another embodiment, the secondary core remains idle while the primary core executes the data obtained from the primary portion of the cache. This enables the secondary core to remain in a stand-by mode for a seamless operation for the multi-core circuit to switch from the primary core to the secondary core upon the fault detection at operation 408.

At operation 406, the secondary portion of the cache is updated to reflect a change in the primary portion of the cache. In one embodiment of operation 406, data is written simultaneously between the primary and the secondary portions of the cache, to create a redundant set of data in the secondary portion of cache, thus any change in the primary portion of the cache is also updated in real time in the secondary portion of the cache. In another embodiment, the secondary portion of the cache and secondary register file are updated when a timer tick expires and/or another level of cache is updated. In a further embodiment, the tinier tick expiration may he a pre-determined number of clock cycles of the multi-core circuit, wherein after reaching the pre-determined number of clock cycles, the multi-core circuit copies the data and address pointer in the primary portion of the cache into the data and address pointer of the secondary portion of the cache and control/status data in the single port register file into the secondary register file.

At operation 408, the multi-core circuit detects the fault condition associated with the primary core. Operation 408 may further include operations 410-412, in which the control circuit obtains the error-correcting code and compares this code to the data executed from the primary portion of the cache by the primary core and written back into the primary portion of the cache to detect the fault condition associated with the primary core. Operation 408 may he similar in functionality to operation 304 as in FIG. 3.

At operation 410, the multi-core circuit obtains an error-correcting code to detect an internal data corruption associated with the primary core and/or the primary portion of the cache. The error-correcting code is data that is considered error-free and used as a redundant data set for comparison to the data written by the primary core into the primary portion of the cache. The error-correcting code may include a bit of data, byte of data, string of data, or other sort of data that is used as redundant data set for comparison. In one embodiment, the error-correcting code may be obtained by the control circuit by a memory within the multi-core circuit. In another embodiment, the error-correcting code may be generated by the control circuit of the multi-core circuit. In operation 410, using the error-correcting code provides a redundant data for a comparison at operation 412.

At operation 412, the multi-core circuit compares the error-correcting code (i.e., error-free data) to the data written to the primary portion of the cache by the primary core to detect an internal data corruption. In one embodiment, in comparing both data sets, a mismatch of the data indicates an internal data corruption (i.e, fault). In another embodiment, if both data sets are similar, this indicates the primary core is operating in normal operation (i.e., fault free).

At operation 414, the control circuit operates the secondary core in response to the detected fault associated with the primary core at operation 408. Operation 414 may be similar in functionality to operation 306 as in FIG. 3.

At operation 416, the secondary core re-executes data that was originally executed by the primary core at operation 404. In operation 416, an address pointer associated with the primary portion of the cache is one code ahead of the address pointer in the secondary portion of the cache, the control unit enables the address pointer to increment until the fault condition is detected with the primary core. Thus, the secondary core re-executes data that was originally executed by the primary core.

FIG. 5 is a block diagram of an example computing device 500 with a processor 502 to execute instructions 506-516 within a machine--readable storage medium 504. Specifically, the computing device 500 with the processor 502 to obtain data from a primary portion of cache for execution by a primary core and operate a secondary core in response to a detected fault condition associated with the primary core. Although the computing device 500 includes processor 502 and machine-readable storage medium 504, it may also include other components that would be suitable to one skilled in the art. For example, the computing device 500 may include the multi-core circuit 102 and 202 as in FIGS. 1-2, respectively. The computing device 500 is an electronic device with the processor 502 capable of executing instructions 506-516 and as such embodiments of the computing device 500 include a computing device, mobile device, client device, personal computer, desktop computer, laptop, tablet, video game console, or other type of electronic device capable of executing instructions 506-516.

The processor 502 may fetch, decode, and execute instructions 506-516. Specifically, the processor 502 executes: instructions 506 for the primary core to obtain data from a primary portion of cache for execution; instructions 508 to write data to the primary and secondary portions of the cache; instructions 510 to receive a signal from the primary core indicating a fault associated with the primary core wherein instructions 510 are further comprising instructions 512 and 514 to compare an error correcting code to data, by the primary core, the data obtained at instructions 506 and transmit a signal to the control unit indicating the fault; and instructions 516 for the control unit to operate the secondary core in response to the signal. In one embodiment, the processor 502 may be similar in structure and functionality to the multi-core sockets 102 and 202 as in FIGS. 1-2, respectively to execute instructions 506-516. In other embodiments, the processor 502 includes a controller, microchip, chipset, electronic circuit, microprocessor, semiconductor, microcontroller, central processing unit (CPU), graphics processing unit (GPU), visual processing unit (VPU), or other programmable device capable of executing instructions 506-516.

The machine-readable storage medium 504 includes instructions 506-516 for the processor to fetch, decode, and execute. In one embodiment, the machine-readable storage medium 504 may include the cache 104 and/or multiple levels of cache 222 as in FIGS. 1-2, respectively. In another embodiment, the machine-readable storage medium 504 may be an electronic, magnetic, optical, memory, storage, flash-drive, or other physical device that contains Of stores executable instructions. Thus, the machine-readable storage medium 504 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 504 may include an application and/or firmware which can be utilized independently and/or in conjunction with the processor 502 to fetch, decode, and/or execute instructions of the machine-readable storage medium 504. The application and/or firmware may be stored on the machine-readable storage medium 504 and/or stored on another location of the computing device 500.

Instructions 506, the primary core obtains data from the primary portion of the cache for execution. instructions 506 include the primary core retrieving the data., executing the data, and then writing the result of the data execution into the primary portion of the cache.

Instructions 508, the control circuit of the multi-core circuit writes the data executed during instructions 506 to the primary and the secondary portions of the cache. Instructions 508 ensure the secondary portion of the cache reflects updates and/or changes that may have occurred in the primary portion of the cache. In this manner, the secondary core may resume operation at the last known data that was executed by the primary core.

Instructions 510, the control circuit receives a signal indicating a fault associated with primary core. In one embodiment, the control circuit detects the fault condition associated with the primary core through utilizing error-correcting code as in instructions 512. Receiving the signal indicating the fault from the primary core, the control circuit enables the operation of the secondary core by switching the operation from the primary core to the secondary core.

Instructions 512, the primary core compares the error-correcting code to data obtained from the primary portion of cache. The data obtained from the primary portion of the cache is data executed by the primary core and written to the primary portion of the cache, in this manner, the primary core compares the data and transmits the signal at instructions 514 to indicate a fault condition within the primary core and/or primary portion of the cache.

Instructions 514-516 include the primary core transmitting the signal to the control circuit indicating the fault condition and in response, the control circuit operates the secondary core to resume an operation of the primary core.

In summary, example embodiments disclosed herein provide fault protection to a multi-core circuit while avoiding component redundancy and without increasing resources. Further, example embodiments provide effective utilization of multiple cores by providing a seamless operation for the multi-core circuit to switch from the primary core to the secondary core upon a fault detection at the primary core.

1. A fault tolerant multi-core circuit comprising:
a primary core associated with a primary portion of a cache;
a secondary core associated with a secondary portion of the cache, the secondary portion of the cache redundant to the primary portion of the cache; and
a control circuit to enable the secondary core for operation in response to a fault condition detected at the primary core, wherein the secondary portion of the cache is enabled with the secondary core to resume an operation of the primary core.

2. The multi-core circuit of claim 1 wherein the fault condition is detected through error-correcting code by the primary core comparing data from the primary portion of the cache to the error-correcting code.

3. The multi-core circuit of claim 1 further comprising:
a dual port register file between the primary core and the secondary core for updates from the primary core.

4. The multi-core circuit of claim 1 further comprising:
multiple levels of cache shared between the primary core and the secondary core.

5. The multi-core circuit of claim 1 further comprising:
a single port register file associated with the primary core to update the primary core with status and control data.

6. The multi-core circuit of claim 1 wherein the secondary core is to remain idle until the fault condition is detected.

7. A method to provide fault tolerant protection within a multi-core circuit, the method comprising:
partitioning a cache into a primary portion associated with a primary core and a secondary portion associated with a secondary core, the secondary portion redundant to the primary portion;
detecting a fault condition associated with the primary core; and
operating the secondary core and associated secondary portion of the cache in response to the detected fault condition.

8. The method of claim 7 wherein the secondary portion of the cache is enabled with the secondary core to resume an operation of the primary core in response to the detected fault condition.

9. The method of claim 7 further comprising:
updating the secondary portion of the cache to reflect a change in the primary portion of the cache when at least one of the following occurs: timer tick expires and another level of cache is updated.

10. The method of claim 7 further comprising:
executing data, by the primary core, obtained from the primary portion of the cache to detect the fault condition associated with the primary core; and
re-executing the data, by the secondary core, obtained from the secondary portion of the cache once the fault condition is detected.

11. The method of claim 7 wherein detecting the fault condition associated with the primary core is further comprising:
obtaining, by the primary core, an error correcting code and data from the primary portion of the cache; and
comparing the error correcting code and the data from the primary portion of the cache to detect the fault condition associated with the primary core.

12. The method of claim 7 further comprising:
executing data, by the primary core, obtained from the primary portion of the cache while the second core remains idle until the fault condition is detected.

13. A non-transitory machine-readable storage medium encoded with instructions executable by a processor of a computing device, the storage medium comprising instructions to:
receive a signal from a primary core associated with a primary portion of a cache, the signal indicating a fault associated with the primary core; and
operate a secondary core associated with a secondary portion of the cache in response to the signal, the secondary portion of the cache redundant to the primary portion of the cache.

14. The non-transitory machine-readable storage medium of claim 12 wherein to receive the signal indicating the fault associated with the primary core is further comprising instructions to:
compare, by the primary core, an error-correcting code data and data obtained from the primary portion of the cache to determine whether the fault is associated with the primary core; and
transmit the signal to a control unit indicating the fault.

15. The non-transitory machine-readable storage medium of claim 12 further comprising instructions to:
obtain data from the primary portion of the cache for execution by the primary core; and
write data to both the primary and the secondary portions of the cache.
